(19) United States
(12) Patent Application Publication
(10) Pub. No.: US 2026/0246760 A1
(43) Pub. Date: Aug. 20, 2026

(54) IP MOBILITY HANDLING FOR SECURE ACCESS SERVICE EDGE (SASE) FOR MOBILE USERS

(71) Applicant: Palo Alto Networks, Inc., Santa Clara, CA (US)

(72) Inventors: Yufeng Zhu, San Jose, CA (US); Enke Chen, San Jose, CA (US); Jining Tian, Saratoga, CA (US); Srivatsan Rajagopal, Cupertino, CA (US)

(21) Appl. No.: 19/058,967

(22) Filed: Feb. 20, 2025

(51) Int. Cl. H04L 9/40; H04L 67/10

(52) U.S. Cl. CPC H04L 63/0236; H04L 63/029; H04L 63/20; H04L 67/10

(57) ABSTRACT

Various techniques for IP mobility handling for Secure Access Service Edge (SASE) for mobile users are disclosed. In some embodiments, a system, a process, and/or a computer program product for techniques for IP mobility handling for SASE for mobile users includes receiving, at a gateway, a request for a secure tunnel connection for a mobile user endpoint (e.g., a mobile user, an application (app) associated with the mobile user, and/or a device associated with the mobile user) to communicate with a secure access service edge (SASE) cloud environment (e.g., associated with a distributed SASE service); assigning a persistent private IP address for the secure tunnel connection to the mobile user endpoint; and performing routing from the SASE cloud environment to the mobile user endpoint over a prioritized secure tunnel using a dynamic routing protocol (DRP) based on an associated sequence number.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 illustrates an architectural diagram for IP mobility handling for Secure Access Service Edge (SASE) for mobile users in accordance with some embodiments.

FIG. 2 is a flow diagram of a process for IP mobility handling for SASE for mobile users in accordance with some embodiments.

FIG. 3 is another flow diagram of a process for IP mobility handling for SASE for mobile users in accordance with some embodiments.

FIG. 4A illustrates an architectural diagram for a legacy shared network for SASE for mobile users in accordance with some embodiments.

FIG. 4B illustrates an architectural diagram for centralized IP address management and secure access control in SASE for mobile users in accordance with some embodiments.

FIG. 5 is a flow diagram of a process for centralized IP address management and secure access control in SASE in accordance with some embodiments.

FIG. 6 is another flow diagram of a process for centralized IP address management and secure access control in SASE in accordance with some embodiments.

FIG. 7A illustrates an architectural diagram for a legacy overlay network for SASE for mobile users in accordance with some embodiments.

FIG. 7B illustrates an architectural diagram for static IP address assignment and microsegmentation in SASE for mobile users in accordance with some embodiments.

FIG. 8 is a flow diagram of a process for static IP address assignment and microsegmentation in SASE in accordance with some embodiments.

FIG. 9A illustrates an architectural diagram for a legacy shared network for SASE for mobile users in accordance with some embodiments.

FIG. 9B illustrates an architectural diagram for geofencing and zero trust security enhancement in overlay networks and SASE environments in accordance with some embodiments.

FIG. 10 is a flow diagram of a process for geofencing and zero trust security enhancement in overlay networks and SASE environments in accordance with some embodiments.

FIG. 11 illustrates an architectural diagram for providing a cloud dynamic host configuration protocol (DHCP) solution with a SASE cloud environment in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks'PA Series next generation firewalls, Palo Alto Networks'VM Series virtualized next generation firewalls, and CN Series container next generation firewalls, which can also be implemented using SD-WAN devices).

For example, Palo Alto Networks'next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks'PA Series next generation firewalls).

Security service providers also offer various commercially available cloud-based security solutions including various firewall, VPN, including Secure Access Service Edge (SASE), and various other security related services. For example, some security service providers have their own data centers in multiple geographies across the world to provide their customers such cloud-based security solutions.

Generally, a secure access service edge (SASE) brings together networking and network security services in a single cloud-based platform. This way, organizations can embrace cloud and mobility while reducing the complexity of dealing with multiple point products as well as saving IT, financial, and human resources.

For example, a SASE solution can generally include networking capabilities that an enterprise already uses. SASE can integrate the following networking features into a cloud-based infrastructure: SD-WAN edge devices, VPN services, and web proxying, which are each further described below.

Software-defined wide area network (SD-WAN) edge devices can provide easier connectivity for branch offices. With SASE, these devices are connected to a cloud-based infrastructure rather than to physical SD-WAN hubs located in other locations. By moving to the cloud, enterprises can eliminate the complexity of managing physical SD-WAN hubs and promote interconnectivity between branch offices.

Virtual private network (VPN) services incorporated by a SASE solution enable enterprises to route traffic through a VPN (e.g., using IPSec tunnels) to the SASE solution, and then to any application in the public or private cloud, delivered via Software as a Service (SaaS), or on the Internet. Traditional VPN was used for remote access to the internal data center, but it is typically not optimized for the current/evolving cloud computing environment.

Web proxying provides an alternate means of securely connecting users to applications by inspecting web-based protocols and traffic. Proxies were typically used for web security enforcement, but due to their inherent security limitations, they are now typically used as an architectural alternative for device traffic that cannot be fully inspected (e.g., personal devices that cannot accept an endpoint agent to force all web and non-web traffic through security inspection). When implemented as part of a SASE solution, proxies can offer organizations with legacy architectures an easier way of adopting the more robust security capabilities SASE has to offer.

In addition, SASE can incorporate the network security service tools enterprises have generally relied upon in prior computing environments. In a comprehensive SASE solution, the following security services can be delivered through a cloud-based infrastructure: zero trust network access (ZTNA), firewall/security as a service (FWaaS), secure web gateways (SWG), data loss prevention (DLP), and cloud access security broker (CASB), which are each further described below.

Zero Trust Network Access (ZTNA) applies the Zero Trust secure computing approach (e.g., never trust, always verify) to the cloud computing environment. For example, ZTNA can be applied to require that every user authenticate to access the cloud, restricting access and minimizing the risk of, for example, data loss. However, ZTNA solutions based on a software-defined perimeter (SDP) model can lack content inspection capabilities needed for consistent security protection for enterprises. Also, moving to a cloud-based SASE infrastructure can eliminate the complexity of connecting to a gateway. For example, users, devices, and apps can be identified no matter where they connect from, and the below further described ZTNA solutions of protecting applications can be applied across all services, including data loss prevention (DLP) and threat prevention.

Firewall as a service (FWaaS) provides next-generation firewall features in the cloud computing environment (e.g., also referred to herein as the cloud), thereby removing the need for physical hardware at branch and retail locations. For example, SASE solutions can integrate FWaaS into its cloud-based platform, allowing simplified management and deployment.

### Overview of Techniques for IP Mobility Handling for Service Access Service Edge (SASE) for Mobile Users

Technical and security challenges with integration of devices connecting with Secure Access Service Edge (SASE) solutions for mobile users (e.g., users using devices that are connecting to the SASE solution from one or more locations, such as working from home offices, remote offices/branches, while traveling, etc.) exist.

Specifically, in an example SASE cloud environment, multiple gateway instances are often deployed to manage large-scale remote access for mobile user clients (e.g., also referred to herein as mobile users). These mobile user clients are prone to frequent switching between gateways due to auto-scaling and/or failover events. As such, technical challenges can arise when, for example, a mobile user client's logout messages fail to reach the previously assigned gateway and then the same private IP address is assigned from the new gateway during such failover switches between these gateways for the mobile user client. Moreover, this situation can also result in half-open tunnels on the server/gateway side, leading to routing conflicts and network instability.

As such, there exists a need for improved integration for IP mobility handling for SASE solutions for mobile users.

Accordingly, new and improved techniques for IP mobility handling for SASE solutions for mobile users are disclosed.

In some embodiments, a system, a process, and/or a computer program product for techniques for IP mobility handling for SASE for mobile users includes receiving, at a gateway, a secure tunnel connection request for a mobile user endpoint (e.g., a mobile user, an application (app) associated with the mobile user, and/or a device associated with the mobile user) to communicate with a secure access service edge (SASE) cloud environment (e.g., associated with a distributed SASE service); assigning a persistent private IP address for the secure tunnel connection to the mobile user endpoint; and performing routing from the SASE cloud environment to the mobile user endpoint over a prioritized secure tunnel using a dynamic routing protocol (DRP) based on an associated sequence number.

For example, scalable cloud gateway management can be provided that specifically addresses the above-described technical challenges related to remote access IP mobility from mobile users in a SASE cloud environment for such secure tunnels/connections (e.g., a virtual private network (VPN) connection between the mobile user endpoint and the SASE cloud via a mobile user gateway).

In an example implementation, a cloud IP address management (CIAM) service receives the secure tunnel connection request and communicates with a global data store to facilitate the persistent private IP address allocation for the secure tunnel connection to the mobile user endpoint. Also, the private IP address allocation can be associated with an IP address pool for a tenant of the SASE service associated with the mobile user endpoint.

In some embodiments, a system, a process, and/or a computer program product for techniques for IP mobility handling for SASE for mobile users further includes assigning an incremented sequence number for each new private IP address allocation to the mobile user endpoint during establishment of a new secure tunnel connection request.

In some embodiments, a system, a process, and/or a computer program product for techniques for IP mobility handling for SASE for mobile users further includes removing/cleaning up an old tunnel at the gateway (e.g., based on an associated timestamp).

In some embodiments, a system, a process, and/or a computer program product for techniques for IP mobility handling for SASE for mobile users further includes performing a duplicate secure tunnel detection using a cloud IP address management (CIAM) service of the SASE cloud environment and a global data store.

In some embodiments, a system, a process, and/or a computer program product for techniques for IP mobility handling for SASE for mobile users further includes detecting a duplicate secure tunnel associated with the gateway and the mobile user endpoint using a cloud IP address management (CIAM) service of the SASE cloud environment and a global data store; and sending a notification to the gateway to release the private IP address associated with the old tunnel on the gateway.

In some embodiments, a system, a process, and/or a computer program product for techniques for IP mobility handling for SASE for mobile users further includes automatically performing a cleanup of old secure tunnels on the gateway in response to receiving a notification of the old secure tunnel from a cloud IP address management (CIAM) service of the SASE cloud environment.

In an example implementation, the disclosed techniques for IP mobility handling for SASE for mobile users facilitate a multi-faceted solution to address the above-described technical challenges by implementing one or more of the following:
1) Sequence Number Enhancement: upon each new IP allocation, the system incrementally increases an associated sequence number for the new IP allocation;
2) Centralized IP Management: a global, centralized IP address management service is deployed;
3) Duplicate Tunnel Detection: the centralized service continuously monitors for duplicate tunnels;
4) Automated Notification System: when a duplicate tunnel is detected, the service automatically provides a duplicate tunnel notification;
5) Proactive Cleanup Protocol: upon receiving the duplicate tunnel notification, the old gateway initiates a cleanup of the duplicate/old tunnel.

Each of these aspects will be further described below with respect to various embodiments.

As such, the disclosed techniques for IP mobility handling for SASE for mobile users provides a comprehensive solution that facilitates efficient IP allocation, minimizes conflicts, and maintains secure network resilience and stability for mobile users connecting via the SASE cloud environment.

For example, the disclosed techniques for IP mobility handling for SASE for mobile users can efficiently manage IP allocation and prevent conflicts (e.g., duplicate tunnels) in a dynamic SASE cloud environment. In an example implementation, by leveraging sequence numbers and a centralized IP address management service, such as will be further described below with respect to various embodiments, the disclosed solution can proactively detect and resolve potential duplicate tunnels. As such, the disclosed solution not only enhances secure network resilience and stability, but it also optimizes resource utilization by promptly cleaning up half-open tunnels as well as facilitating more efficient utilization of limited IP address pool resources.

Furthermore, the disclosed solution's scalability and adaptability make it particularly effective in handling the frequent gateway switches that are prevalent in large-scale remote access scenarios, thereby ensuring seamless and uninterrupted service for mobile user clients that are connecting to an enterprise network/Internet and resources via the SASE cloud environment.

These and other embodiments and aspects of the disclosed techniques for IP mobility handling for SASE solutions for mobile users will now be further described below.

### Example System Embodiments for IP Mobility Handling for Service Access Service Edge (SASE) for Mobile Users

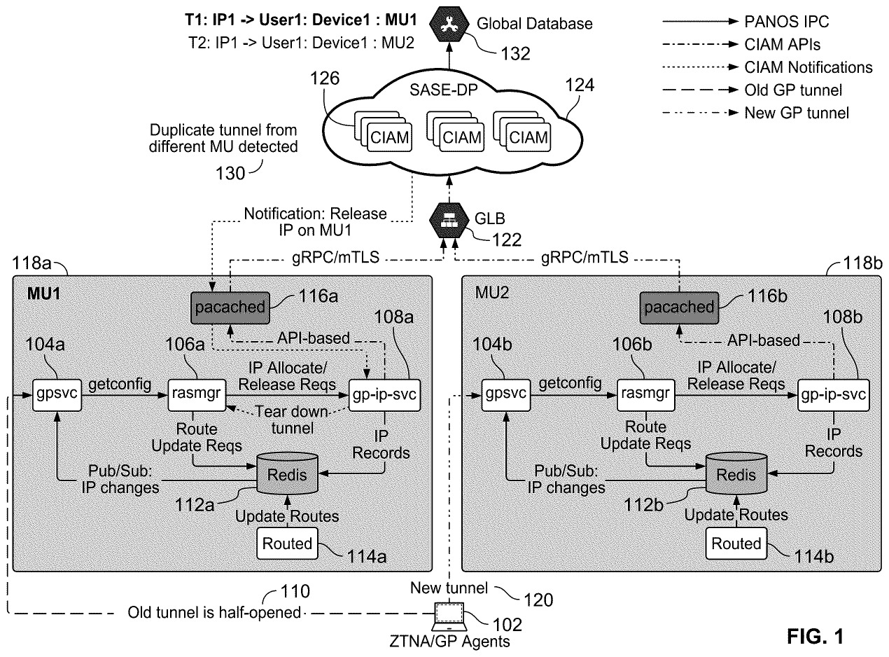

FIG. 1 illustrates an architectural diagram for IP mobility handling for Secure Access Service Edge (SASE) for mobile users in accordance with some embodiments.

As shown in FIG. 1, a mobile user device 102 executes a SASE connector agent for securely connecting to a SASE cloud environment (e.g., SASE data plane (DP) network) as shown at 124. In an example implementation, the SASE connector agent is a zero trust network access (ZTNA) agent or a Global Protect (GP) agent, such as commercially available from Palo Alto Networks, Inc., headquartered in Santa Clara, CA, and/or another publicly or commercially available ZTNA agent can similarly be used to facilitate secure network connectivity with a SASE cloud environment.

In this example implementation, the ZTNA/GP agent facilitates a secure tunnel (e.g., virtual private network (VPN) tunnel) with the SASE cloud environment. Specifically, the ZTNA/GP agent connects to the SASE cloud environment via a mobile user (MU) gateway, such as MU1 as shown at 118a using an old tunnel 110 or MU2 as shown at 118b using a new tunnel 120. As also shown, each of MU1 and MU2 is in network communication with the SASE cloud environment via a global load balancer (GLB) 122.

In an example implementation, the disclosed techniques for IP mobility handling for SASE for mobile users facilitates a multi-faceted solution to address the above-described technical challenges by implementing one or more of the following:
1) Sequence Number Enhancement: upon each new IP allocation, the system incrementally increases an associated sequence number for the new IP allocation (e.g., upon each new IP allocation, the disclosed solution incrementally increases a unique sequence number associated with the mobile user/client connection and assigns the sequence number to a dynamic routing protocol as a metric to resolve routing conflicts, such as BGP metric=65535 as an example assigned sequence number, such as further described below);
2) Centralized IP Management: a global, centralized IP address management service is deployed to facilitate, for example, (near) real-time awareness of all active client connections across the SASE cloud network environment for mobile user/client connections;
3) Duplicate Tunnel Detection: the centralized service continuously monitors for duplicate tunnels (e.g., the centralized service continuously monitors for duplicate tunnels by comparing the client identifiers and sequence numbers, such as further described below);
4) Automated Notification System: when a duplicate tunnel is detected, the service automatically provides a duplicate tunnel notification (e.g., when a duplicate tunnel is detected, the disclosed solution automatically generates and sends a notification to the MU gateway holding the outdated connection, which can be implemented, for example, using publish/subscribe (pub/sub) channels or using heartbeat messages between the MU gateways and the SASE cloud environment/service, such as further described below);
5) Proactive Cleanup Protocol: upon receiving the duplicate tunnel notification, the old gateway initiates a cleanup of the duplicate/old tunnel (e.g., upon receiving the notification, the old MU gateway, such as shown at 110 in FIG. 1, initiates a cleanup process to terminate and remove any half-opened tunnels associated with the mobile user device/client, such as further described below).

Each of these aspects will now be further described below with respect to FIG. 1.

Referring to FIG. 1, mobile user device 102 executes a SASE connector agent (e.g., ZTNA/GP agents) that facilitates authentication (e.g., using user credentials, such as username and password, and/or additional multi-factor authentication (MFA)) for the mobile user to securely connect to the MU gateway via a secure/VPN tunnel. As such, the VPN endpoints are mobile user devices and the MU gateway. In this example implementation, the initial connection request is received at the MU gateway (e.g., MU1 118a or MU2 118b), which is received at a VPN connection service component of the MU gateway (e.g., gpsvc entity, such as shown at 104a for MU1 118a and 104b for MU2 118b). As will be further described below, the MU gateway sends IP allocation requests to the cloud IP address management (CIAM) service (126) located in the SASE-DP (124). The SASE-DP serves as a control plane only as the data packets will pass through the SASE-DP to, for example, an on-premises (on-prem) data center (not shown in FIG. 1).

If the connection request is authorized (e.g., the credentials/MFA are validated for the incoming new VPN connection request), then the gpsvc entity sends a getconfig request to a remote access manager (rasmgr) component (e.g., rasmgr entity, such as shown at 106a for MU1 118a and 106b for MU2 118b) to get a private IP address for the new VPN connection between mobile user device 102 and the MU gateway (e.g., MU1 118a or MU2 118b).

The MU gateway will then proceed to allocate a private IP address for the validated incoming VPN connection request as will now be described below. The rasmgr then sends the IP allocate request to an IP service component (e.g., gp-ip-svc entity, such as shown at 108a for MU1 118a and 108b for MU2 118b). In this example implementation, the IP service component sends the IP allocation request using an application programming interface (API) call (e.g., or other communication mechanisms can similarly be used) to the SASE cloud environment via a communication cache component (e.g., pacached, such as shown at 116a of MU1 118a and 116b for MU2 118b). The API call can be securely communicated via a gRPC or mTLS communication from the MU gateway to the SASE cloud environment, such as shown in FIG. 1.

The API-based IP allocation request is received at a cloud IP address management (CIAM) service (e.g., a microservice, which can be implemented using virtual machines or containers in the SASE-DP cloud environment), such as shown at 126 of the SASE cloud environment. In this example implementation, there are multiple instances of the CIAM service, such as for scalability and/or failover, etc. In response to the IP allocation request, the CIAM service performs a lookup in a global database 132 (e.g., implemented using a cloud data store/database (DB), such as the Google Cloud Platform (GCP) cloud spanner DB or another publicly/commercially available DB can be similarly used, such as for scalability, etc.). In this example implementation, the global database stores private IP addresses associated with mobile user clients/devices connected to the SASE cloud environment. For example, for a new connection request for a mobile user client/device (e.g., there is not a previously allocated private IP address for that user and device, such as further described below), then the CIAM service can select a private IP address from an IP address pool allocated for a given tenant (e.g., the mobile user client/device can be associated with a given enterprise tenant of the SASE cloud service). The assigned private IP address is then communicated back to the MU gateway via the IP allocation service. The IP address assignment records are updated locally in the MU gateway in a local data store, shown as a Redis (e.g., as shown at 112a in MU1 118a and 112b in MU2 118b), and the routes for such new connections are updated in the Routed component (e.g., as shown at 114a in MU1 118a and 114b in MU2 118b). In this example implementation, IP address changes can be communicated via a publish/subscribe (pub/sub) communication mechanism (e.g., or another similar communication mechanism can be similarly used) via the gpsvc component as shown in FIG. 1.

In this example implementation, the lookup for private IP address allocation using the global database is performed based on a user and a device to determine whether there exists a private IP address that is already allocated to that user and device. If there is not a previously allocated IP address, then the CIAM service can select a private IP address from an IP address pool allocated for a given tenant (e.g., the mobile user client/device can be associated with a given enterprise tenant of the SASE cloud service), such as similarly described above. Otherwise (e.g., there is a previously assigned private IP address for that user and device), then the CIAM service assigns the same private IP address to that user and device to provide for private IP address persistency (e.g., private IP address stickiness).

After the mobile user logs out, then a similar process for an IP address release is performed as shown in FIG. 1, which is communicated from the MU gateway to the CIAM service for updating the global database to indicate that the assigned private IP address was released by the mobile user device. In an example implementation, the private IP address allocation can be soft deleted from the global database to maintain a private IP address assignment history to facilitate private IP address persistency for such mobile user devices, as similarly described above. As such, when the same mobile user and device subsequently requests a private IP address, then the CIAM service in communication with the global database can assign the same private IP address (e.g., marked as previously assigned and released by that mobile user and device) to that mobile user and device. If there is no record(s) in the global database for previously assigned IP addresses for that mobile user and device, then a new private IP address can be assigned (e.g., based on tenant and an IP address pool(s) associated with that tenant), such as similarly described above.

Referring to the network routing performed using the MU gateways, the assigned private IP address is stored in the Redis data store/cache as similarly described above. In an example implementation, the MU gateways are implemented in software, such as virtual machines (VMs) or containers (e.g., Kubernetes pods), and/or as physical gateways, executing a Linux or other operating system (OS). The routing/forwarding tables are also updated a the Routed component for persistently storing these routes (e.g., for redundancy, this route information and private IP address allocation is replicated/cached in the Redis cache of the MU gateway), such as similarly described above.

As also shown in FIG. 1, regarding the closing of a tunnel/VPN connection, the SASE connector agent executed on the mobile user device (102) can terminate an old tunnel. However, the logout message may not reach MU1 118a, which results in the tunnel remaining half-opened on the MU1 gateway/server side, as shown in this example of FIG. 1. When the SASE connector agent executed on the mobile user device (102) initiates a new tunnel/VPN connection request, then the mobile user device may connect to a different MU gateway, such as the MU2 gateway/server side, as shown in this example of FIG. 1. As described above, the new tunnel/VPN connection can be assigned the same/previously allocated private IP address. However, this can result in routing conflicts from the SASE side, impeding the correct flow of reverse traffic to the intended MU gateways. As such, the disclosed techniques for IP mobility handling for SASE users can also include a solution for detection of duplicate tunnels from the CIAM service (126) and send a notification to the old MU gateway to release the private IP address on that MU gateway and to clean up the associated half-opened tunnel(s) as shown at 130 in FIG. 1, such as will now be further described below.

Accordingly, in some embodiments, to address this routing conflict that can arise due to the private IP persistency solution described above for these tunnels/VPN connections between the mobile user devices and the SASE cloud environment, the Routed component will also update/store a sequence number associated with the private IP address and route for each new/assigned tunnel/VPN connection when generating a new routing entry in the routing/forwarding tables, which is then also stored/cached in the Redis cache of the MU gateway. In an example implementation, the routing protocol (e.g., a dynamic routing protocol (DRP)) utilizes the lowest sequence number as high priority (e.g., for sequence numbers of, for example, 100 and 200, then the route associated with sequence number 100 will be given priority) to facilitate route selection for tunnels/VPN connections over distinct MU gateways with a given mobile user device (e.g., or in another example implementation, this can be implemented using a maximum number, such as of 65,000 minus the assigned sequence number to determine the routing for these tunnels/VPN connections, in which case the lowest resulting value can be used as the priority route(s) for the routing protocol for these tunnels/VPN connections). In an example implementation, old tunnels at the MU gateways can be removed (e.g., based on an associated timestamp associated with the tunnels, if a newer timestamp for a tunnel associated with a given mobile user endpoint exists, which can be stored in the global database (132), then the tunnel(s) associated with that mobile user endpoint can be deemed old, and then can be removed/torn down, such as similarly described above).

Additional example processes for the disclosed techniques for IP mobility handling for SASE users will now be further described below.

### Example Process Embodiments for IP Mobility Handling for Service Access Service Edge (SASE) for Mobile Users

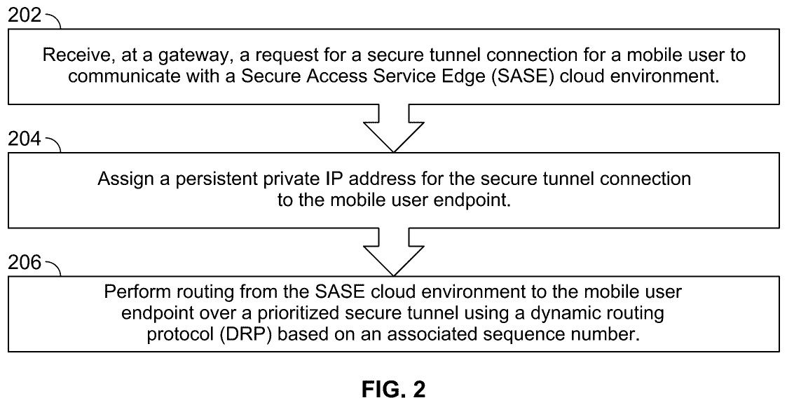

FIG. 2 is a flow diagram of a process for IP mobility handling for SASE for mobile users in accordance with some embodiments. In some embodiments, a process as shown in FIG. 2 is performed by the SASE solution and techniques as similarly described above including the embodiments described above with respect to FIG. 1. In one embodiment, the process is performed, at least in part, by MU gateways 118a/118b, CIAM service 126, and global database 132 as described above with respect to FIG. 1.

The process begins at 202. At 202, a secure tunnel connection request for a mobile user endpoint to communicate with a secure access service edge (SASE) cloud environment is received at a gateway. For example, the gateway can be a mobile user gateway, such as similarly described above with respect to FIG. 1.

At 204, a persistent private IP address for the secure tunnel connection is assigned to the mobile user endpoint. As also similarly described above, the mobile user gateway can increment a sequence number associated with the allocated/assigned private IP address.

At 206, routing from the SASE cloud environment to the mobile user endpoint is performed over a prioritized secure tunnel using a dynamic routing protocol (DRP) based on an associated sequence number.

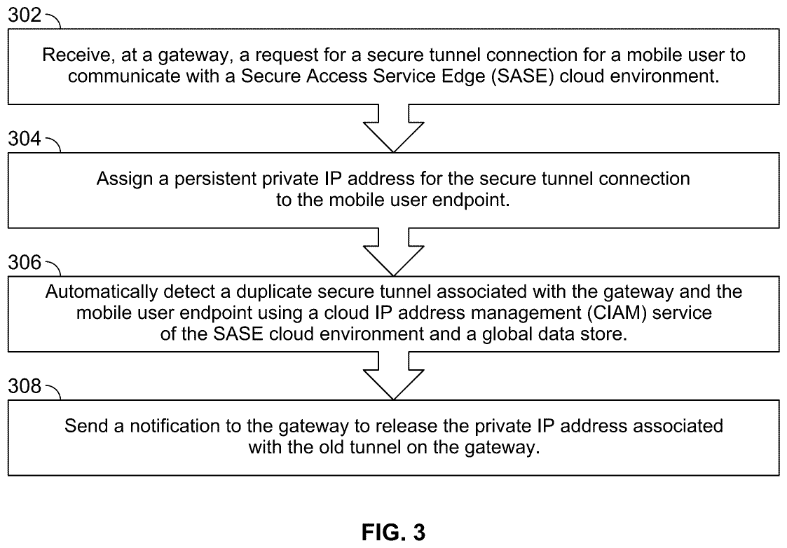

FIG. 3 is another flow diagram of a process for IP mobility handling for SASE for mobile users in accordance with some embodiments. In some embodiments, a process as shown in FIG. 3 is performed by the SASE solution and techniques as similarly described above including the embodiments described above with respect to FIG. 1. In one embodiment, the process is performed, at least in part, by MU gateways 118a/118b, CIAM service 126, and global database 132 as described above with respect to FIG. 1.

The process begins at 302. At 302, a secure tunnel connection request for a mobile user endpoint to communicate with a secure access service edge (SASE) cloud environment is received at a gateway. For example, the gateway can be a mobile user gateway, such as similarly described above with respect to FIG. 1.

At 304, a persistent private IP address for the secure tunnel connection is assigned to the mobile user endpoint. As also similarly described above, the mobile user gateway can increment a sequence number associated with the allocated/assigned private IP address.

At 306, a duplicate secure tunnel associated with the gateway and the mobile user endpoint is automatically detected using a cloud IP address management (CIAM) service of the SASE cloud environment and a global data store.

At 308, a notification is sent to the gateway to release the private IP address associated with the old tunnel on the gateway. In an example implementation, the mobile user gateway can perform a clean-up of the old tunnel in response to the notification from the CIAM service of the SASE cloud environment, such as similarly described above with respect to FIG. 1.

### Overview of Techniques for Centralized IP Address Management and Secure Access Control in Service Access Service Edge (SASE)

Technical and security challenges with integration of devices connecting with Secure Access Service Edge (SASE) solutions for mobile users (e.g., users using devices that are connecting to the SASE solution from one or more locations, such as working from home offices, remote offices/branches, while traveling, etc.) exists.

Specifically, in an example SASE cloud environment, the management of IP address allocation for mobile user clients presents significant challenges that impact both operational efficiency and security, such as further described below.

First, the typical approaches to the management of IP address allocation for mobile user clients result in inefficient IP address pool utilization. For example, the legacy gateway-based IP pool management approach leads to substantial inefficiencies, typically requiring IP pool sizes 2-4 times larger than the actual number of users due to address fragmentation across gateways. This overprovisioning results in suboptimal resource utilization and increases operational costs.

Second, the typical approaches to the management of IP address allocation for mobile user clients result in security vulnerabilities. For example, the absence of a global, centralized IP assignment tracking mechanism introduces significant security risks. In scenarios where user credentials are compromised, malicious actors can potentially establish connections from multiple locations or endpoints simultaneously. The current system's inability to detect and prevent such unauthorized multi-point access poses a severe security threat, including risks of account takeover and unauthorized account sharing.

Third, the typical approaches to the management of IP address allocation for mobile user clients result in limited global visibility. For example, the current gateway-based IP pool management system lacks a comprehensive, network-wide view of IP address assignments. This limitation hinders the ability to effectively optimize IP allocation across the entire SASE infrastructure and detect anomalous login patterns.

As such, there exists a need for improved centralized IP address management and secure access control in SASE (e.g., for SASE solutions for mobile users).

Accordingly, new and improved techniques for centralized IP address management and secure access control for SASE solutions for mobile users are disclosed.

In some embodiments, a system, a process, and/or a computer program product for techniques for centralized IP address management and secure access control in SASE includes receiving, at a gateway, a request for a secure tunnel connection for a mobile user endpoint to communicate with a secure access service edge (SASE) cloud environment; assigning a private IP address from a consistent IP address pool for the secure tunnel connection to the mobile user endpoint; and monitoring a plurality of active user sessions across the SASE cloud environment for a global view of private IP address assignments

As such, the disclosed techniques for centralized IP address management and secure access control in SASE facilitate optimized IP address utilization. For example, the utilized IP address pool size can be significantly reduced (e.g., from two to four times the number of mobile users to equal to the number of mobile users). Also, IP fragmentation is minimized across the gateways (MU gateways). Thus, overall IP address resource efficiency is improved in these SASE environments.

In addition, the disclosed techniques for centralized IP address management and secure access control in SASE facilitate an enhanced security posture for enterprise customers of the SASE solution. For example, the disclosed techniques for centralized IP address management and secure access control in SASE can be implemented to provide global concurrent session control, detect and prevent account takeovers, and/or identify and mitigate unauthorized account sharing, such as will be further described below with respect to various embodiments.

Moreover, the disclosed techniques for centralized IP address management and secure access control in SASE provide improved visibility and control for IP address resources. For example, the disclosed techniques for centralized IP address management and secure access control in SASE can be implemented to provide a comprehensive, real-time view of IP assignments across the entire network, enable proactive management of IP resources and user sessions, and/or support advanced analytics for network optimization and security intelligence, such as will be further described below with respect to various embodiments.

Further, the disclosed techniques for centralized IP address management and secure access control in SASE facilitate scalability and flexibility associated with usage of IP address resources. For example, the disclosed techniques for centralized IP address management and secure access control in SASE can be implemented to adapt seamlessly to dynamic SASE environments with multiple gateway instances and/or to support efficient IP management for large-scale remote access scenarios, such as will be further described below with respect to various embodiments.

Finally, the disclosed techniques for centralized IP address management and secure access control in SASE provide a cost-effective solution for IP address resource utilization. For example, the disclosed techniques for centralized IP address management and secure access control in SASE reduce operational costs associated with over-provisioning IP addresses and/or minimize potential security breach costs through improved threat detection and prevention, such as will be further described below with respect to various embodiments.

These and other embodiments and aspects of the disclosed techniques for centralized IP address management and secure access control in SASE will now be further described below.

### Example System Embodiments for Centralized IP Address Management and Secure Access Control in Service Access Service Edge (SASE)

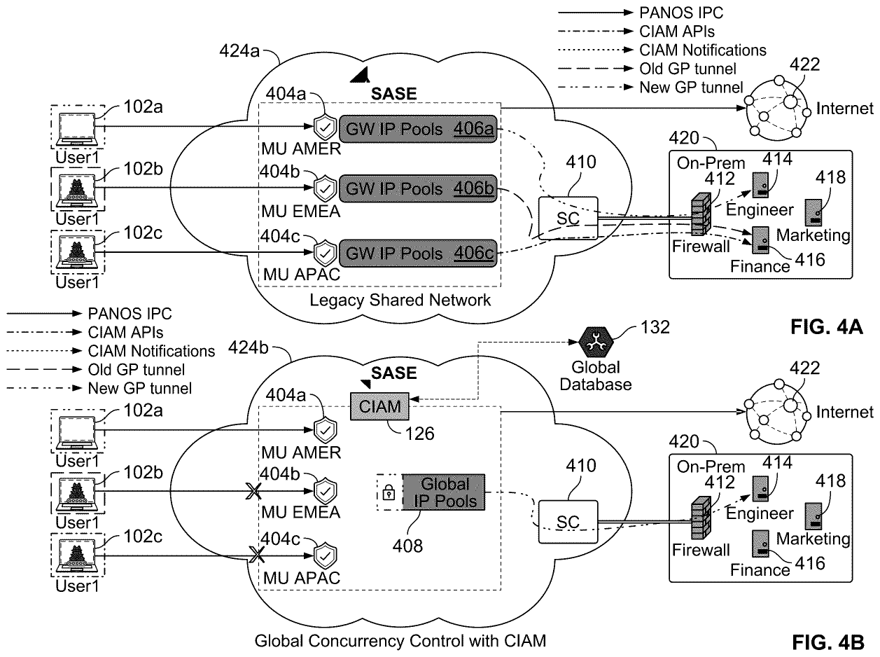

FIG. 4A illustrates an architectural diagram for a legacy shared network for SASE for mobile users in accordance with some embodiments.

FIG. 4B illustrates an architectural diagram for centralized IP address management and secure access control in SASE for mobile users in accordance with some embodiments. Specifically, FIG. 4B provides an architectural diagram for IP mobility handling for Secure Access Service Edge (SASE) for mobile users that provides global concurrency control with a Centralized IP Address Management (CIAM) solution, such as will be further described below.

As shown in FIGS. 4A and 4B, a mobile user device, such as shown at 102a, 102b, and 102c, executes a SASE connector agent for securely connecting (e.g., via a VPN) to a mobile user (MU) gateway, such as shown at 404a, 404b, and 404c, for access to a SASE cloud environment (e.g., SASE data plane (DP) network) as shown at 424a and 424b, respectively. In an example implementation, the SASE connector agent is a zero trust network access (ZTNA) agent or a Global Protect (GP) agent, such as commercially available from Palo Alto Networks, Inc., headquartered in Santa Clara, CA, and/or another publicly or commercially available ZTNA agent can similarly be used to facilitate secure network connectivity with a SASE cloud environment, such as similarly described above with respect to FIG. 1.

Referring to FIG. 4A, in this legacy shared network example for a SASE implementation for IP address handling for mobile users, each MU gateway 404a (e.g., for the Americas region), 404b (e.g., for the Europe, Middle East, and Africa (EMEA) region), and 404c (e.g., for the Asia Pacific (APAC) region) uses its own distinct gateway (GW) IP address pool as shown at 406a, 406b, and 406c respectively.

However, this legacy shared network approach results in an inefficient IP address resource utilization, such as will be further described below.

Moreover, this legacy shared network approach results in security vulnerabilities associated with secure access control, such as will also be further described below.

Thus, there exists a need for centralized IP address management and secure access control in SASE for mobile users.

Accordingly, various techniques for centralized IP address management and secure access control in SASE for mobile users will now be further described below.

Referring now to FIG. 4B, in this new and improved shared network example for a SASE implementation for IP address handling for mobile users, global concurrency control is facilitated using a CIAM solution, such as similarly described above with respect to FIG. 1. Specifically, each of MU gateway 404a (e.g., for the Americas region), 404b (e.g., for the Europe, Middle East, and Africa (EMEA) region), and 404c (e.g., for the Asia Pacific (APAC) region) uses a global IP address pool 408 and a CIAM solution 126.

As shown in FIG. 4B, mobile user devices, each as shown at 102a, 102b, and 102c, execute a SASE connector agent (e.g., ZTNA/GP agents) that facilitates authentication (e.g., using user credentials, such as username and password, and/or additional multi-factor authentication (MFA)) for the mobile user to securely connect to the MU gateway via a secure/VPN tunnel. As such, the VPN endpoints are mobile user devices and the MU gateway. In this example implementation, the initial connection request is received at the MU gateway (e.g., MU 404a, 404b, or 404c), which is received at a VPN connection service component of the MU gateway (e.g., gpsvc entity, such as shown at 104a for MU1 118a and 104b for MU2 118b, as shown in FIG. 1, not shown in FIG. 4B; the connection request processing at the MU gateways can be implemented as similarly described above with respect to FIG. 1). As will be further described below, the MU gateway sends IP allocation requests to the cloud IP address management (CIAM) service (126) located in the SASE environment (424b) (e.g., also generally referred to herein as a SASE-data plane (DP) environment). The CIAM service in the SASE-DP serves as a control plane only as the data packets will pass through the SASE-DP via a service connection (SC) entity/gateway 410 to, for example, an on-premises (on-prem) data center 420 or for access to other resources via the Internet 422 (e.g., SaaS applications, web sites and web-based services, etc.). As also shown in FIG. 4B, the on-prem data center includes various resources, which are located behind a perimeter firewall/NGFW 412, including an engineer resource/server 414, a finance resource/server 416, and a marketing resource/server 418.

If the connection request is authorized (e.g., the credentials/MFA are validated for the incoming new VPN connection request, in which the connection request processing at the MU gateways can be implemented as similarly described above with respect to FIG. 1), then the MU gateway will then proceed to allocate a private IP address for the validated incoming VPN connection request, which can be implemented as similarly described above with respect to FIG. 1 (e.g., using an API call, which can be securely communicated via a gRPC or mTLS communication from the MU gateway to the SASE cloud environment, such as shown in FIG. 1).

The above-described IP allocation request is received at the cloud IP address management (CIAM) service (e.g., a microservice, which can be implemented using virtual machines or containers in the SASE-DP cloud environment), such as shown at 126 of the SASE cloud environment. In an example implementation, multiple instances of the CIAM service can be provided in the SASE cloud environment, such as for scalability and/or failover, etc. as similarly described above and as shown in FIG. 1. In response to the IP allocation request, the CIAM service performs a lookup in global database 132 (e.g., the global database can be implemented using a cloud data store/database (DB), such as the Google Cloud Platform (GCP) cloud spanner DB or another publicly/commercially available DB can be similarly used, such as for scalability, etc., such as similarly described above with respect to FIG. 1). In this example implementation, the global database stores private IP addresses, which are allocated from a global IP address pool 408, that are associated with mobile user clients/devices connected to the SASE cloud environment.

For example, for a new connection request for a mobile user client/device (e.g., there is not a previously allocated private IP address for that user and device, such as further described below), then the CIAM service can select a private IP address from global IP address pool 408, which can be the global IP address pool that is allocated for a given tenant (e.g., the mobile user client/device can be associated with a given enterprise tenant of the SASE cloud service). The assigned private IP address is then communicated back to the MU gateway via the IP allocation service. The IP address assignment records are updated locally in the MU gateway (e.g., cached/stored in a local data store, such as a Redis as shown at 112a in MU1 118a and 112b in MU2 118b of FIG. 1, not shown in FIG. 4B), and the routes for such new connections are updated in the Routed component (e.g., as shown at 114a in MU1 118a and 114b in MU2 118b of FIG. 1, not shown in FIG. 4B). In this example implementation, IP address changes can be communicated via a publish/subscribe (pub/sub) communication mechanism (e.g., or another similar communication mechanism can be similarly used) via the gpsvc component, such as similarly described above and as shown in FIG. 1.

### Centralized IP Address Management in SASE

As such, the disclosed techniques for centralized IP address management and secure access control in SASE provide a centralized IP address management solution for overlay VPN tunnels in SASE environments.

Specifically, the disclosed techniques for centralized IP address management and secure access control in SASE facilitate global IP address pool management. The above-described centralized service using CIAM 126, global IP address pool 408, and global database 132 effectively and efficiently manages IP address allocation across all regions and gateway instances using the global database (132), thereby ensuring optimal utilization of the IP address pool. In an example implementation, IP addresses are allocated efficiently, minimizing fragmentation, and reducing the required IP pool size to match the actual number of users by using an application-specific IP address allocation algorithm that can be based on and/or adapted to a given customer use case/pattern of IP address allocation for that given customer (e.g., based on historical patterns).

In this example implementation, the lookup for private IP address allocation using the global database is performed based on a user and a device to determine whether there exists a private IP address that is already allocated to that user and device. If there is not a previously allocated IP address, then the CIAM service can select a private IP address from an IP address pool allocated for a given tenant (e.g., the mobile user client/device can be associated with a given enterprise tenant of the SASE cloud service), such as similarly described above. Otherwise (e.g., there is a previously assigned private IP address for that user and device), then the CIAM service assigns the same private IP address to that user and device to provide for private IP address persistency (e.g., private IP address stickiness).

### Security Enhancements Using Centralized IP Address Management and Secure Access Control in SASE

As such, the disclosed techniques for centralized IP address management and secure access control in SASE also provide a centralized IP address management solution for security enhancements for IP address allocations in SASE environments.

For example, if there is a previously assigned private IP address for that user and device, and that session is still active and/or the IP address associated with that session has not been released or timed out as similarly described above with respect to FIG. 1, then the centralized IP address management solution can effectively perform concurrent session detection and control. If a tenant does not allow a user to have multiple concurrent sessions to the SASE cloud environment, then such requests for additional IP address allocations associated with the user for a concurrent session can be blocked/denied, which facilitates an effective solution for providing a concurrent session and control.

As another example, if there is a previously assigned private IP address for that user and device, and that session is still active and/or the IP address associated with that session has not been released or timed out as similarly described above with respect to FIG. 1 (e.g., there is a record(s) in the global database for a currently assigned IP address for that mobile user), then the centralized IP address management solution can also effectively perform anomaly detection for potential account takeovers. As shown in FIGS. 4A and 4B, credentials for a User1 at different devices 102a, 102b, and 102c are shown connecting or attempting to connect to MU gateways in three different regions, MU 404A in the Americas, MU 404B in EMEA, and MU 404C in APAC. As shown in FIG. 4A, each of those connections are allocated a private IP address and allowed to connect to the MUs and access the SASE cloud environment. In contrast, as shown in FIG. 4B, the additional connection attempts from user devices 102b to MU 404b and 102c to MU 404C are denied/blocked as the centralized IP address management solution detects that the user has an existing/active connection via MU 404a. Moreover, these additional connection attempts can be deemed to be anomalous and potential account takeovers given that they are attempting to connect in different geographical regions (e.g., the user would not be simultaneously located in the Americas and another region, such as EMEA or APAC).

As yet another example, if there is a previously assigned private IP address for that user and device, and that session is still active and/or the IP address associated with that session has not been released or timed out as similarly described above with respect to FIG. 1 (e.g., there is a record(s) in the global database for a currently assigned IP address for that mobile user), then the centralized IP address management solution can also effectively detect account sharing. For example, if a given user shares their credentials with another user (e.g., another employee or contractor), then the additional connection attempt using such credentials can similarly be detected by the centralized IP address management solution, such as when multiple connection attempts are overlapping during a given period of time (e.g., using multi-point access monitoring), such as similarly described above with respect to anomaly detection and potential account takeovers.

### Real-Time Monitoring and Visibility Using Centralized IP Address Management and Secure Access Control in SASE

As such, the disclosed techniques for centralized IP address management and secure access control in SASE also provide a centralized IP address management solution for real-time monitoring and visibility for IP address allocations in SASE environments.

For example, if there is a previously assigned private IP address for that user and device, and that session is still active and/or the IP address associated with that session has not been released or timed out as similarly described above with respect to FIG. 1, then the centralized IP address management solution can effectively perform real-time monitoring and visibility. Specifically, in an example implementation, the centralized IP address management solution continuously monitors and tracks all active user sessions across the entire network (e.g., SASE cloud environment), providing a global view of IP address assignments (e.g., based on record(s) in the global database for currently assigned IP addresses for mobile users as similarly described above).

Accordingly, the disclosed techniques for centralized IP address management and secure access control in SASE can implement a centralized IP address management system for global IP address pool (e.g., IP pool) management for private IP address allocations to mobile users connecting to mobile user (MU) gateways. Specifically, a centralized service can be provided to effectively and efficiently manage IP address allocation across all regions and gateway instances (e.g., in which IP addresses can be efficiently assigned, minimizing fragmentation and reducing security vulnerabilities), such as described above and as will be further described below with respect to various embodiments.

In this example implementation, the centralized IP address management solution also implements robust security measures, including the following: (1) concurrent session detection and control; (2) anomaly detection for potential account takeovers; and (3) account sharing prevention through multi-point access monitoring.

In this example implementation, the centralized IP address management solution also implements real-time monitoring and visibility. For example, the centralized IP address management solution can continuously monitor and track all active user sessions across the entire network. As another example, advanced analytics for network optimization and security intelligence can be generated using the above-described CIAM service based on private IP address allocation and usage for mobile users for the SASE cloud environment. As yet another example, the above-described centralized IP address management solution can be applied to facilitate multi-cloud centralized IP address management and security access control in SASE.

Additional example processes for the disclosed techniques for centralized IP address management and secure access control in SASE will now be further described below.

### Example Process Embodiments for Centralized IP Address Management and Secure Access Control in Service Access Service Edge (SASE)

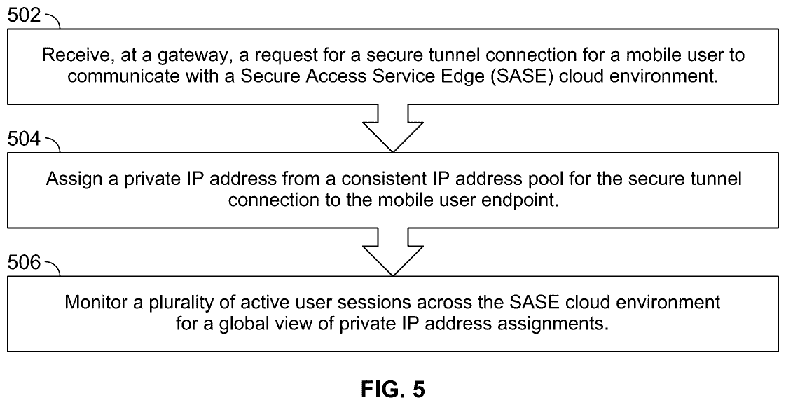

FIG. 5 is a flow diagram of a process for centralized IP address management and secure access control in SASE in accordance with some embodiments. In some embodiments, a process as shown in FIG. 5 is performed by the SASE solution and techniques as similarly described above including the system embodiments and components described above with respect to FIGS. 1 and 4B. In example implementations, the process is performed, at least in part, by MU gateways 118a/118b and 404a/404b/404c, CIAM service 126, and global database 132 as described above with respect to FIGS. 1 and 4B.

The process begins at 502. At 502, a secure tunnel connection request for a mobile user endpoint to communicate with a secure access service edge (SASE) cloud environment is received at a gateway. For example, the gateway can be a mobile user gateway, such as similarly described above with respect to FIG. 4B.

At 504, a persistent private IP address from a consistent IP address pool for the secure tunnel connection is assigned to the mobile user endpoint. As also similarly described above, the allocated/assigned private IP address can be from a consistent, global IP address pool for mobile users associated with a given tenant of the SASE service. For example, a cloud IP address management (CIAM) service can receive the secure tunnel connection request and communicate with a global data store to facilitate a persistent private IP address allocation for the secure tunnel connection to the mobile user endpoint, and the private IP address allocation can be associated with an IP address pool for a tenant of a SASE service associated with the mobile user endpoint, such as similarly described above with respect to FIGS. 1 and 4B.

At 506, monitoring a plurality of active user sessions across the SASE cloud environment for a global view of private IP address assignments is performed. For example, the CIAM service using the global database can provide continuous, real-time monitoring of IP address assignments for the SASE cloud environment for a global view of private IP address assignments, such as similarly described above with respect to FIG. 4B.

As another example, the CIAM service using the global database can also perform proactive management of IP resources and user sessions, such as similarly described above with respect to FIG. 4B.

As yet another example, the CIAM service using the global database can also generate analytics for network optimization of IP resources and security intelligence, such as similarly described above with respect to FIG. 4B.

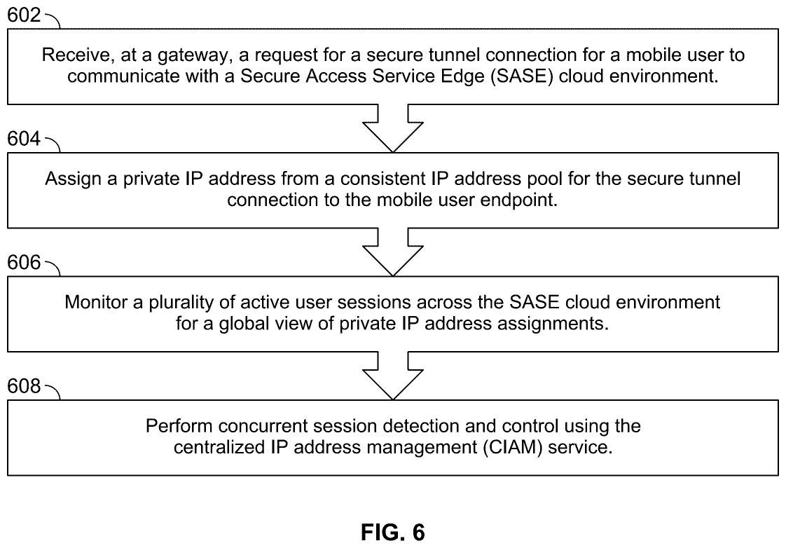

FIG. 6 is another flow diagram of a process for centralized IP address management and secure access control in SASE in accordance with some embodiments. In some embodiments, a process as shown in FIG. 6 is performed by the SASE solution and techniques as similarly described above including the system embodiments and components described above with respect to FIGS. 1 and 4B. In example implementations, the process is performed, at least in part, by MU gateways 118a/118b and 404a/404b/404c, CIAM service 126, and global database 132 as described above with respect to FIGS. 1 and 4B.

The process begins at 602. At 602, a secure tunnel connection request for a mobile user endpoint to communicate with a secure access service edge (SASE) cloud environment is received at a gateway. For example, the gateway can be a mobile user gateway, such as similarly described above with respect to FIG. 4B.

At 604, a persistent private IP address from a consistent IP address pool for the secure tunnel connection is assigned to the mobile user endpoint. As also similarly described above, the allocated/assigned private IP address can be from a consistent, global IP address pool for mobile users associated with a given tenant of the SASE service. For example, a cloud IP address management (CIAM) service can receive the secure tunnel connection request and communicate with a global data store to facilitate a persistent private IP address allocation for the secure tunnel connection to the mobile user endpoint, and the private IP address allocation can be associated with an IP address pool for a tenant of a SASE service associated with the mobile user endpoint, such as similarly described above with respect to FIGS. 1 and 4B.

At 606, monitoring a plurality of active user sessions across the SASE cloud environment for a global view of private IP address assignments is performed. For example, the CIAM service using the global database can provide continuous, real-time monitoring of IP address assignments for the SASE cloud environment for a global view of private IP address assignments, such as similarly described above with respect to FIG. 4B.

At 608, concurrent session detection and control using the CIAM service is performed. For example, the CIAM service using the global database can also perform anomaly detection and an account takeover, such as similarly described above with respect to FIG. 4B.

As another example, the CIAM service using the global database can also perform account sharing prevention through multipoint access monitoring, such as similarly described above with respect to FIG. 4B.

As yet another example, the CIAM service using the global database can also perform continuous, real-time monitoring of IP address assignments for the SASE cloud environment, such as similarly described above with respect to FIG. 4B.

### Example System Embodiments for Static IP Address Assignment and Microsegmentation for Enhanced Security in Service Access Service Edge (SASE)

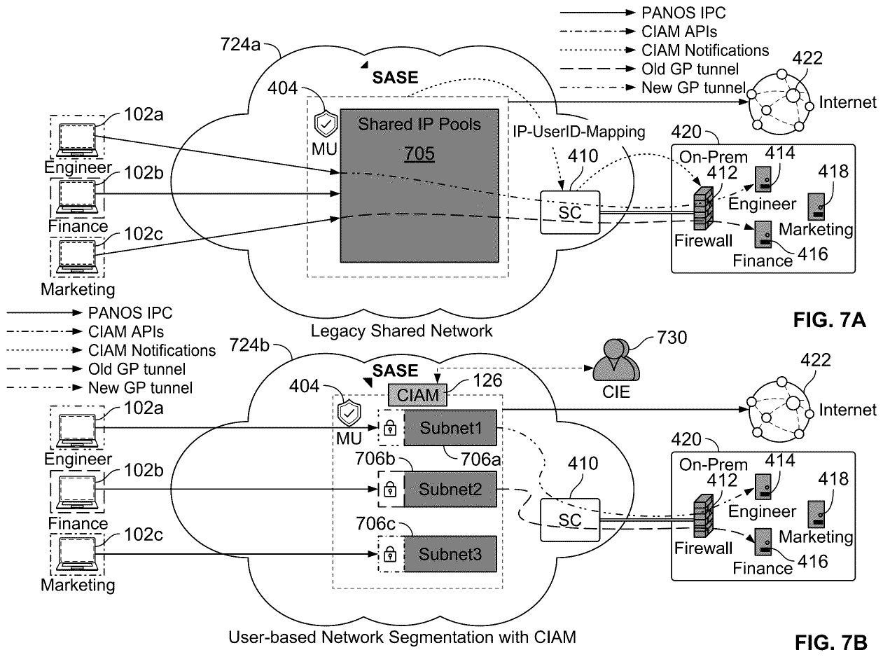

FIG. 7A illustrates an architectural diagram for a legacy overlay network for SASE for mobile users in accordance with some embodiments.

FIG. 7B illustrates an architectural diagram for static IP address assignment and microsegmentation in SASE for mobile users in accordance with some embodiments.

As shown in FIGS. 7A and 7B, a mobile user device, such as shown at 102a, 102b, and 102c, which are each associated with different enterprise roles, such as engineering, finance, and marketing as shown in FIGS. 7A and 7B, respectively, executes a SASE connector agent for securely connecting (e.g., via a VPN) to a mobile user (MU) gateway, such as shown at 404 for access to a SASE cloud environment (e.g., SASE data plane (DP) network) as shown at 724a and 724b, respectively. In an example implementation, the SASE connector agent is a zero trust network access (ZTNA) agent or a Global Protect (GP) agent, such as commercially available from Palo Alto Networks, Inc., headquartered in Santa Clara, CA, and/or another publicly or commercially available ZTNA agent can similarly be used to facilitate secure network connectivity with a SASE cloud environment, such as similarly described above with respect to FIG. 1.

Referring to FIG. 7A, in legacy overlay networks and Secure Access Service Edge (SASE) cloud environments, such as shown in FIG. 7A, private IP addresses for mobile user clients are dynamically allocated from a shared IP address pool(s), such as shown at 705 of SASE cloud environment 724A in FIG. 7A. These IP-User mappings are then synchronized with on-premises firewalls, such as firewall 412 in FIG. 7A.

However, this legacy overlay networks and SASE approach presents several technical challenges, such as will now be described below.

Compatibility Issues: On-premises firewalls generally need to interpret and understand the IP-user mappings to implement user-based security policies effectively. This requirement often leads to compatibility issues with third-party firewalls, limiting flexibility and potentially increasing operational complexity for enterprises using SASE solutions.

Security Policy Implementation: The dynamic nature of IP allocation generally makes it technically challenging and inefficient/time consuming to maintain consistent and granular security policies, as the association between users and IP addresses is constantly changing.

Lateral Movement Risk: Generally, all mobile users operate within a shared network space, significantly increasing the risk of lateral movement attacks. If an attacker compromises a given user's credentials, then the attacker can potentially access other parts of the enterprise network thereby increasing security risks for such enterprises using SASE solutions.

Audit and Compliance Challenges: Dynamic IP allocation also generally complicates the process of tracking user activities and maintaining compliance with various regulatory requirements.

Thus, there exists a need for static IP address assignment and microsegmentation in SASE for mobile users.

Accordingly, various techniques for static IP address assignment and microsegmentation in SASE for mobile users will now be further described below.

Specifically, in this example implementation, the disclosed techniques include providing static IP address management and network segmentation within SASE environments.

Static IP Address Assignment: Instead of dynamic allocation, IP addresses are assigned statically based on individual users or user groups. For example, this static IP address assignment is performed intelligently, accounting for factors such as user roles (e.g., engineering, finance, marketing, etc.), access requirements, and security clearance levels.

Microsegmentation: Users are placed into distinct microsegmented networks (e.g., such as shown at 706a, 706b, and 706c in FIG. 7B as further described below), creating isolated environments that significantly reduce the security risks associated with lateral movement as similarly discussed above.

More specifically, as shown in FIG. 7B, a cloud identity engine (CIE) 730 provides an intelligent IP address management component that correlates user identities with specific IP ranges or subnets to facilitate static IP address assignment and microsegmentation in SASE for mobile users. In an example implementation, CIE 730 can communicate with an identity service to perform the user identity lookup for the enterprise user (e.g., the identity service can include a lightweight directory access protocol (LDAP) component/service or a service that provides LDAP-integration, such as commercially available from Okta, which is available at https://www.okta.com/ldap/, or another similar component/service that can provide such user identity information as would be apparent to one of ordinary skill in the art). Also, CIAM 126, which is in communication with CIE 730, is configured to implement a microsegmentation engine that creates and manages isolated network segments based on predefined security policies, such as further described below.

Referring now to FIG. 7B, mobile user devices, each as shown at 102a (e.g., engineering associated user/device), 102b (e.g., finance associated user/device), and 102c (e.g., marketing associated user/device), execute a SASE connector agent (e.g., ZTNA/GP agents) that facilitates authentication (e.g., using user credentials, such as username and password, and/or additional multi-factor authentication (MFA)) for the mobile user to securely connect to the MU gateway via a secure/VPN tunnel. As such, the VPN endpoints are mobile user devices and the MU gateway. In this example implementation, the initial connection request is received at the MU gateway 404, which is received at a VPN connection service component of the MU gateway (e.g., gpsvc entity, such as shown at 104a for MU1 118a and 104b for MU2 118b, as shown in FIG. 1, not shown in FIG. 7B; the connection request processing at the MU gateways can be implemented as similarly described above with respect to FIG. 1). As will be further described below, the MU gateway sends static IP allocation requests to the cloud IP address management (CIAM) service (126) located in the SASE environment (724b) (e.g., also generally referred to herein as a SASE-data plane (DP) environment). The SASE-DP serves as a control plane only as the data packets will pass through the SASE-DP to, for example, an on-premises (on-prem) data center 420 or for access to other resources via the Internet 422 (e.g., SaaS applications, web sites and web-based services, etc.). As also shown in FIG. 7B, the on-prem data center includes various resources, which are located behind a perimeter firewall/NGFW 412, including an engineer resource/server 414, a finance resource/server 416, and a marketing resource/server 418.

If the connection request is authorized (e.g., the credentials/MFA are validated for the incoming new VPN connection request, in which the connection request processing at the MU gateways can be implemented as similarly described above with respect to FIG. 1), then the MU gateway will then proceed to allocate a static private IP address for the validated incoming VPN connection request, which can be implemented as similarly described above with respect to FIG. 1 (e.g., using an API call, which can be securely communicated via a gRPC or mTLS communication from the MU gateway to the SASE cloud environment, such as shown in FIG. 1).

The above-described IP allocation request is received at the cloud IP address management (CIAM) service (e.g., a microservice, which can be implemented using virtual machines or containers in the SASE-DP cloud environment), such as shown at 126 of the SASE cloud environment. In an example implementation, multiple instances of the CIAM service can be provided in the SASE cloud environment, such as for scalability and/or failover, etc. as similarly described above and as shown in FIG. 1. In response to the IP allocation request, the CIAM service communicates with CIE 730. CIE 730 is configured to implement a microsegmentation engine that creates and manages isolated network segments based on predefined security policies. Specifically, CIE 730 can determine that a given user is associated with a user group in a predefined security policy, such as an engineering user group, a finance user group, and/or a marketing user group. Based on the user group association, the CIE can then allocate an IP address with a predefined subnet for that user group, such as subnet1 706a for the engineering user group, subnet2 706b for a finance user group, or subnet3 706c for the marketing user group.

In addition, in some implementations, the CIAM in coordination with the CIE can also be configured to perform a lookup in global database 132 (not shown in FIG. 7B) (e.g., the global database can be implemented using a cloud data store/database (DB), such as the Google Cloud Platform (GCP) cloud spanner DB or another publicly/commercially available DB can be similarly used, such as for scalability, etc., such as similarly described above with respect to FIG. 1). In this example implementation, the global database stores private IP addresses, which are allocated from subnet IP address pools 706a, 706b, and 706c, that are associated with mobile user clients/devices connected to the SASE cloud environment. As such, in this example implementation, the same global DB can also be used for storing the IP assignment information, in which the CIE provides, for example, the user/group context, which seamlessly integrates with CIAM's IP allocation policy matching conditions.

Accordingly, the disclosed techniques for static IP address assignment and microsegmentation in SASE for mobile users facilitate enhanced security for SASE solutions. For example, by implementing microsegmentation, the disclosed techniques for static IP address assignment and microsegmentation in SASE for mobile users significantly reduce the attack surface and limit the potential impact of a security breach.

In addition, the disclosed techniques for static IP address assignment and microsegmentation in SASE for mobile users simplify network/security policy management for enterprises. For example, on-premises firewalls can implement security policies based on IP addresses or subnets, eliminating the need for complex IP-user mapping interpretations.

Further, the disclosed techniques for static IP address assignment and microsegmentation in SASE for mobile users facilitate improved compatibility. For example, given that on-premises firewalls can implement security policies based on IP addresses or subnets, eliminating the need for complex IP-user mapping interpretations, the disclosed techniques are compatible with a wide range of third-party firewalls (e.g., as it relies on standard IP-based rules rather than (proprietary) user-mapping protocols).

Also, the disclosed techniques for static IP address assignment and microsegmentation in SASE for mobile users provide for effective lateral movement prevention. For example, users are isolated in different network segments, such as described above with respect to FIG. 7B, thereby significantly hindering an attacker's ability to move laterally within the network.

Further, the disclosed techniques for static IP address assignment and microsegmentation in SASE for mobile users include audit and compliance benefits. For example, static IP assignment and clear network segmentation simplifies user activity tracking and support compliance with various regulatory requirements.

Moreover, the disclosed techniques for static IP address assignment and microsegmentation in SASE for mobile users provide for consistent security across environments. For example, the disclosed techniques provide a uniform approach to security policy enforcement across both cloud-based SASE and on-premises environments, such as similarly described above with respect to FIG. 7B.

Finally, the disclosed techniques for static IP address assignment and microsegmentation in SASE for mobile users facilitate granular access control. For example, information technology (IT)/network/security administrators can implement fine-grained access policies based on both user identity and network location, enhancing the overall security posture for their enterprise network environments.

Additional example processes for the disclosed techniques for static IP address assignment and microsegmentation in SASE for mobile users will now be further described below.

### Example Process Embodiments for Static IP Address Assignment and MicroSegmentation for Enhanced Security in Service Access Service Edge (SASE)

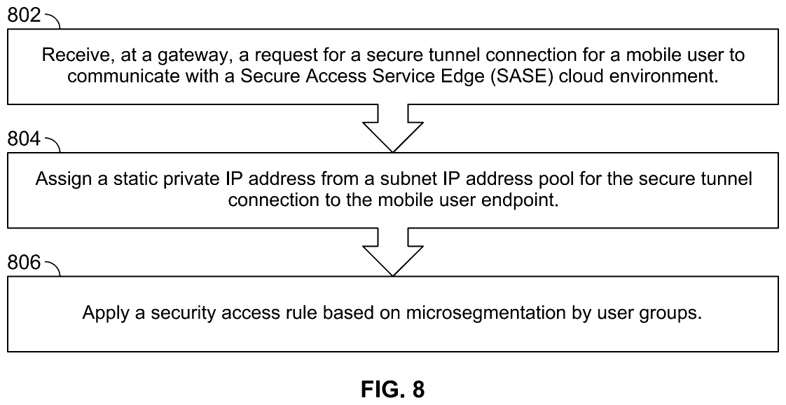

FIG. 8 is a flow diagram of a process for static IP address assignment and microsegmentation in SASE in accordance with some embodiments. In some embodiments, a process as shown in FIG. 8 is performed by the SASE solution and techniques as similarly described above including the system embodiments and components described above with respect to FIGS. 1 and 7B. In example implementations, the process is performed, at least in part, by MU gateways 118a/118b and 404, CIAM service 126, and global database 132 as described above with respect to FIGS. 1 and 7B.

The process begins at 802. At 802, a secure tunnel connection request for a mobile user endpoint to communicate with a secure access service edge (SASE) cloud environment is received at a gateway. For example, the gateway can be a mobile user gateway, such as similarly described above with respect to FIG. 7B.

At 804, a static private IP address from a subnet IP address pool for the secure tunnel connection is assigned to the mobile user endpoint. As also similarly described above, the allocated/assigned private IP address can be from a subnet IP address pool for mobile users associated with a particular user group in an enterprise policy for a given tenant of the SASE service. For example, a cloud IP address management (CIAM) service can receive the secure tunnel connection request and communicate with a CIE (e.g., including performing a user lookup in an identity service) to facilitate a static private IP address allocation for the secure tunnel connection to the mobile user endpoint, and the static IP address allocation can be associated with a subnet IP address pool for a tenant of a SASE service associated with the mobile user endpoint based on a user group in the enterprise policy, such as similarly described above with respect to FIG. 7B.

At 806, applying a security access rule based on microsegmentation by user groups is performed. For example, the access to on-prem resources can be determined by the on-prem firewall based on the microsegmentation by user groups (e.g., only users on subnet1 706a can access an engineering resource 414 as enforced by firewall 412), such as similarly described above with respect to FIG. 7B.

### Example System Embodiments for Geofencing and Zero Trust Security Enhancement in Overlay Networks and Service Access Service Edge (SASE) Environments

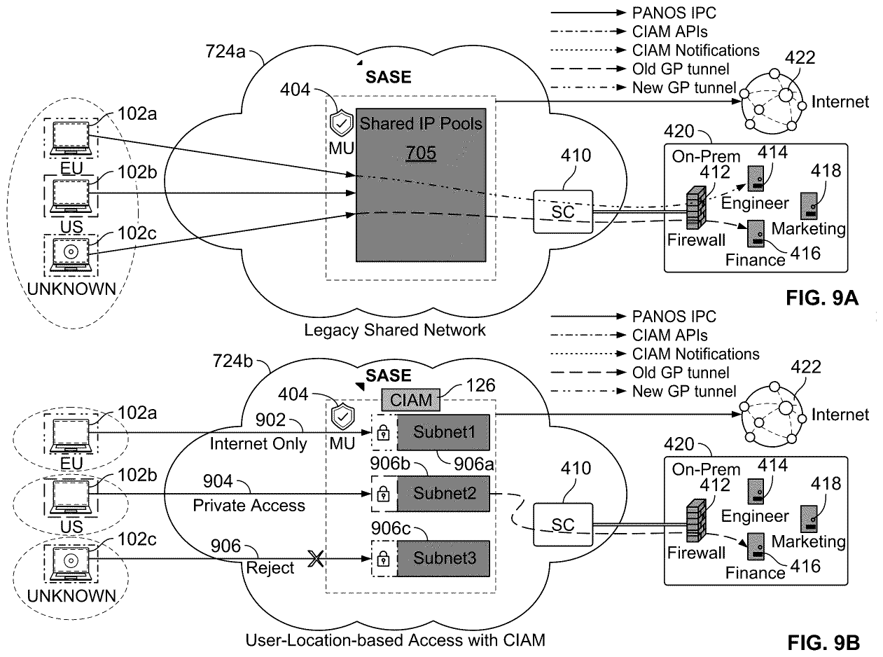

FIG. 9A illustrates an architectural diagram for a legacy shared network for SASE for mobile users in accordance with some embodiments.

FIG. 9B illustrates an architectural diagram for geofencing and zero trust security enhancement in overlay networks and SASE environments in accordance with some embodiments.

As shown in FIGS. 9A and 9B, a mobile user device, such as shown at 102a, 102b, and 102c, which are each associated with different geographical locations (geolocations), such as Europe (EU), United States (US), and unknown, as shown in FIGS. 9A and 9B, respectively, executes a SASE connector agent for securely connecting (e.g., via a VPN) to a mobile user (MU) gateway, such as shown at 404 for access to a SASE cloud environment (e.g., SASE data plane (DP) network) as shown at 724a and 724b, respectively. In an example implementation, the SASE connector agent is a zero trust network access (ZTNA) agent or a Global Protect (GP) agent, such as commercially available from Palo Alto Networks, Inc., headquartered in Santa Clara, CA, and/or another publicly or commercially available ZTNA agent can similarly be used to facilitate secure network connectivity with a SASE cloud environment, such as similarly described above with respect to FIG. 1.

Referring to FIG. 9A, in legacy shared networks and Secure Access Service Edge (SASE) cloud environments, such as shown in FIG. 9A, private IP addresses for mobile user clients are dynamically allocated from a shared IP address pool(s), such as shown at 705 of SASE cloud environment 724A in FIG. 9A.

However, this legacy shared networks and SASE approach presents several technical challenges, such as will now be described below.

In traditional network security implementations, firewalls and security services typically apply policies based on user geolocation by extracting information from the client's public IP address using geolocation services (e.g., geolocation database APIs, etc.). However, this approach fails when dealing with overlay tunnels, in which security services only have visibility of private IP addresses assigned to such overlay tunnels. As such, these assigned private IP addresses typically lack the necessary geolocation mapping, rendering geolocation-based security policies ineffective for such overlay network traffic.

This geolocation related limitation for such private IP addresses for overlay network traffic poses significant security risks, particularly in SASE environments and other overlay network architectures without the ability to discern user geolocation in overlay networks, such as will now be further described below.

First, any location could potentially access services, circumventing geolocation-based access controls.

Second, the core principles of zero trust security and location-aware access policies are undermined.

Third, enterprises are exposed to unauthorized access and potential data breaches.

Fourth, compliance with regional data protection regulations become even more technically challenging.

Fifth, the ability to implement effective geofencing strategies is severely limited.

As such, these issues create a critical gap in security posture, leaving enterprises vulnerable to sophisticated cyber threats that exploit the lack of location awareness in overlay networks.

Thus, there exists a need for geofencing and zero trust security enhancement in overlay networks and SASE environments.

Accordingly, various techniques for geofencing and zero trust security enhancement in overlay networks and SASE environments will now be further described below.

Specifically, in this example implementation, the disclosed techniques include allocating private IP addresses within overlay tunnels. This allocation is based on the public IP address of the underlying tunnel, effectively preserving the geolocation information. As a result, enterprise customers of the SASE service can effectively apply security policies based on the allocated private IP addresses or subnets, which now indirectly represent the original geolocation data, such as will be further described below with respect to FIG. 9B.

As such, the disclosed techniques for geofencing and zero trust security enhancement in overlay networks and SASE environments bridge the gap between overlay network architecture and geolocation-based security, enabling organizations to perform the following: (1) maintain location-aware security policies in SASE and other overlay network environments; (2) enhance their zero-trust security posture by incorporating reliable location data into access decisions; and (3) mitigate the risk of unauthorized access from restricted geographical areas.

Referring now to FIG. 9B, mobile user devices, each as shown at 102a (e.g., user/device located in the EU), 102b (e.g., a user/device located in the US), and 102c (e.g., a user/device with an unknown location), execute a SASE connector agent (e.g., ZTNA/GP agents) that facilitates authentication (e.g., using user credentials, such as username and password, and/or additional multi-factor authentication (MFA)) for the mobile user to securely connect to the MU gateway via a secure/VPN tunnel. As such, the VPN endpoints are mobile user devices and the MU gateway. In this example implementation, the initial connection request is received at the MU gateway 404, which is received at a VPN connection service component of the MU gateway (e.g., gpsvc entity, such as shown at 104a for MU1 118a and 104b for MU2 118b, as shown in FIG. 1, not shown in FIG. 9B; the connection request processing at the MU gateways can be implemented as similarly described above with respect to FIG. 1). As will be further described below, the MU gateway sends static IP allocation requests to the cloud IP address management (CIAM) service (126) located in the SASE environment (724b) (e.g., also generally referred to herein as a SASE-data plane (DP) environment). The CIAM service in the SASE-DP serves as a control plane only as the data packets will pass through the SASE-DP to, for example, an on-premises (on-prem) data center 420 or for access to other resources via the Internet 422 (e.g., SaaS applications, web sites and web-based services, etc.). As also shown in FIG. 7B, the on-prem data center includes various resources, which are located behind a perimeter firewall/NGFW 412, including an engineer resource/server 414, a finance resource/server 416, and a marketing resource/server 418.

If the connection request is authorized (e.g., the credentials/MFA are validated for the incoming new VPN connection request, in which the connection request processing at the MU gateways can be implemented as similarly described above with respect to FIG. 1), then the MU gateway will then proceed to allocate a static private IP address for the validated incoming VPN connection request, which can be implemented as similarly described above with respect to FIG. 1 (e.g., using an API call, which can be securely communicated via a gRPC or mTLS communication from the MU gateway to the SASE cloud environment, such as shown in FIG. 1).

The above-described IP allocation request is received at the cloud IP address management (CIAM) service (e.g., a microservice, which can be implemented using virtual machines or containers in the SASE-DP cloud environment), such as shown at 126 of the SASE cloud environment. In an example implementation, multiple instances of the CIAM service can be provided in the SASE cloud environment, such as for scalability and/or failover, etc. as similarly described above and as shown in FIG. 1. In response to the IP allocation request, the CIAM service is configured to implement a microsegmentation engine that creates and manages isolated network segments based on predefined security policies. Specifically, the CIAM service can determine that a given user/device is associated with a predetermined location in a predefined security policy, such as a geolocation of the US/Americas, EU/EMEA, APAC, and/or an unknown geolocation. Based on the user/device location association, the CIAM service can then allocate an IP address with a predefined subnet for that location, such as subnet1 906a for the EU location, subnet2 906b for the US location, or a subnet3 906c for the unknown location as shown in FIG. 9B.

As such, allocation is based on the public IP address of the underlying tunnel, effectively preserving the geolocation information. As a result, enterprise customers of the SASE service can effectively apply security policies based on the allocated private IP addresses or subnets, which now indirectly represent the original geolocation data. As an example, a connection request for a user/device associated with an EU location can be allocated Internet only access based on a network/security policy for the enterprise, such as shown at 902. As another example, a connection request for a user/device associated with a US location can be allocated private access based on a network/security policy for the enterprise, such as shown at 904. As yet another example, a connection request for a user/device associated with an unknown location can be rejected based on a network/security policy for the enterprise, such as shown at 906.

In addition, in some implementations, the CIAM service can also be configured to perform a lookup in global database 132 (not shown in FIG. 9B) (e.g., the global database can be implemented using a cloud data store/database (DB), such as the Google Cloud Platform (GCP) cloud spanner DB or another publicly/commercially available DB can be similarly used, such as for scalability, etc., such as similarly described above with respect to FIG. 1). In this example implementation, the global database stores private IP addresses, which are allocated from subnet IP address pools 906a, 906b, and 906c, that are associated with mobile user clients/devices connected to the SASE cloud environment.

Accordingly, the disclosed techniques for geofencing and zero trust security enhancement in overlay networks and SASE environments facilitate enhanced network segmentation by, for example, enabling geolocation-based network segmentation within overlay networks, and thereby also improving security granularity.

Also, the disclosed techniques for geofencing and zero trust security enhancement in overlay networks and SASE environments provide for fine-grained access control. For example, the disclosed techniques provide for more precise access control policies based on geographical contexts, even in complex network architectures.

Further, the disclosed techniques for geofencing and zero trust security enhancement in overlay networks and SASE environments facilitate firewall independence by, for example, eliminating the need for specialized firewall capabilities to handle geolocation-based policies in overlay networks.

In addition, the disclosed techniques for geofencing and zero trust security enhancement in overlay networks and SASE environments allow for a consistent security policy by, for example, providing a uniform approach to applying geolocation-based security policies across both SASE and on-prem firewall implementations.

Finally, the disclosed techniques for geofencing and zero trust security enhancement in overlay networks and SASE environments facilitate improved overlay network security by, for example, extending geolocation-based security features to overlay networks.

Additional example processes for the disclosed techniques for geofencing and zero trust security enhancement in overlay networks and SASE environments will now be further described below.

### Example Process Embodiments for Geofencing and Zero Trust Security Enhancement in Overlay Networks and Service Access Service Edge (SASE) Environments

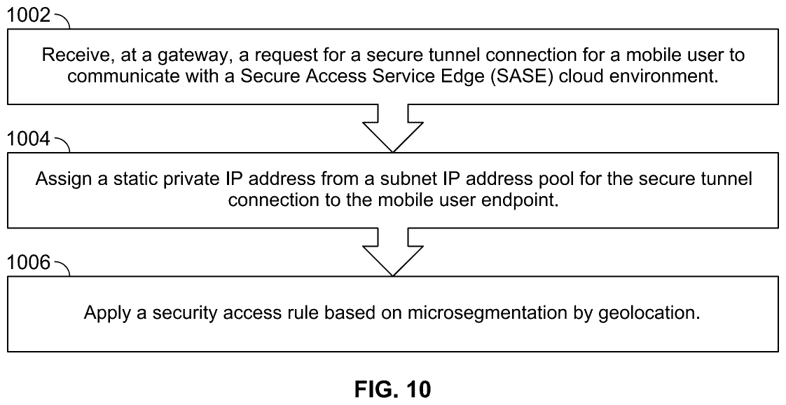

FIG. 10 is a flow diagram of a process for geofencing and zero trust security enhancement in overlay networks and SASE environments in accordance with some embodiments. In some embodiments, a process as shown in FIG. 10 is performed by the SASE solution and techniques as similarly described above including the system embodiments and components described above with respect to FIGS. 1 and 9B. In example implementations, the process is performed, at least in part, by MU gateways 118a/118b and 404, CIAM service 126, and global database 132 as described above with respect to FIGS. 1 and 9B.

The process begins at 1002. At 1002, a secure tunnel connection request for a mobile user endpoint to communicate with a secure access service edge (SASE) cloud environment is received at a gateway. For example, the gateway can be a mobile user gateway, such as similarly described above with respect to FIG. 9B.

At 1004, a static private IP address from a subnet IP address pool for the secure tunnel connection is assigned to the mobile user endpoint. As also similarly described above, the allocated/assigned private IP address can be from a subnet IP address pool for mobile users associated with a particular user/device location in an enterprise policy for a given tenant of the SASE service. For example, a cloud IP address management (CIAM) service can receive the secure tunnel connection request to facilitate a static private IP address allocation for the secure tunnel connection to the mobile user endpoint based on the user/device geolocation associated with the underlying tunnel, and the static IP address allocation can be associated with a subnet IP address pool for a tenant of a SASE service associated with the mobile user endpoint based on the associated geolocation for that user/device in the enterprise policy so that the overlay tunnel maintains that geolocation information and a security access rule can be applied/enforced based on that geolocation information (e.g., an on-prem firewall can apply security access rules based on that geolocation information pursuant to an enterprise configured firewall security policy), such as similarly described above with respect to FIG. 9B.

At 1006, applying a security access rule based on microsegmentation by geolocation is performed. For example, the access to on-prem resources can be determined by the on-prem firewall based on the microsegmentation by geolocation (e.g., only users on subnet2 906b can access private/on-prem resources as enforced by firewall 412), such as similarly described above with respect to FIG. 9B.

### Example System and Process Embodiments for a Cloud Dynamic Host Configuration Protocol (DHCP) Solution with SASE

In some embodiments, the disclosed techniques can also be applied to facilitate a cloud DHCP solution with SASE as will now be further described below.

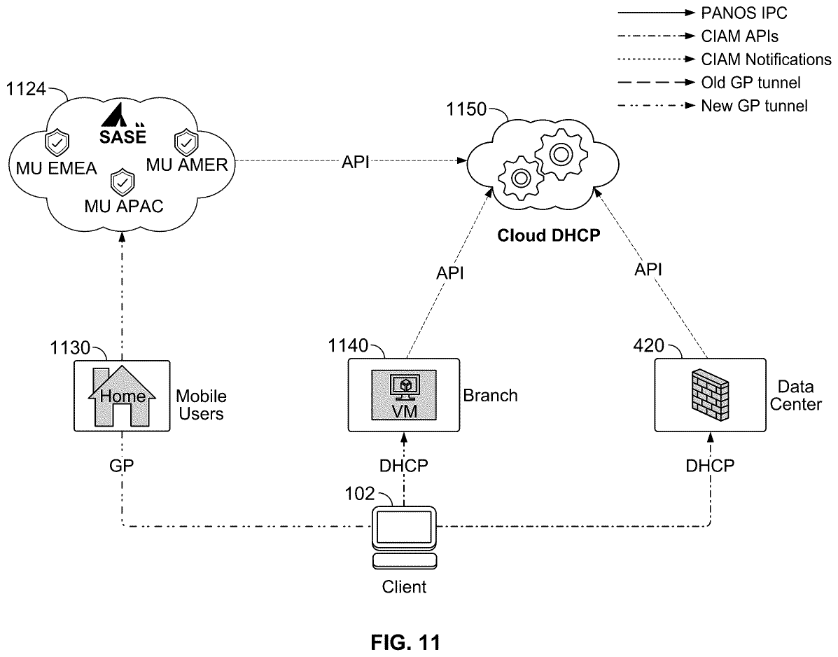

FIG. 11 illustrates an architectural diagram for providing a cloud dynamic host configuration protocol (DHCP) solution with a SASE cloud environment in accordance with some embodiments.

Referring to FIG. 11, the disclosed techniques for a cloud DHCP solution with a SASE cloud environment can be applied for providing a cloud-based, centralized, unified, efficient DHCP service 1150 by integrating the CIAM service with a security platform (e.g., NGFW) or third DHCP server virtual machine (VM) entity, such as shown at 1140, for a branch/satellite office of an enterprise.

Specifically, the NGFW or DHCP server VM 1140 can provide a frontend that is in communication with a DHCP client executed on client 102 and communicating using the DHCP protocol as shown in FIG. 11.

In this example implementation, the CIAM service can be provided as a backend that is providing centralized, unified, and context-aware IP address management.

As also shown, mobile users 1130 can connect with the SASE service 1124 using an MU gateway, such as similarly described above with respect to various embodiments.

As such, the NGFW or DHCP VM provides a relay of the IP allocation/release/renew request to the CIAM service (e.g., via APIs, such as further described below). In this example implementation, the CIAM service is a function/entity located in SASE cloud environment 1124 (not shown in FIG. 11), such as similarly described above with respect to various embodiments.

Accordingly, the disclosed techniques for a cloud DHCP solution with a SASE cloud environment facilitate extending the SASE service to on-prem and eliminating on-prem DHCP servers.

In addition, the disclosed techniques for a cloud DHCP solution with a SASE cloud environment can significantly simplify IP address management (IPAM) with multiple office locations ensuring consistent network policies and more efficient IP address management.

Further, the disclosed techniques for a cloud DHCP solution with a SASE cloud environment provide persistent IP address and consistent IP-User mapping.

In an example implementation, cloud DHCP service APIs are provided as shown below.

### Example Control Plane Apis

POST/ciam/v1/tenants/{tenant_id}/ip-pool-rules
PUT/ciam/v1/tenants/{tenant_id}/ip-pool-rules/{rule_id}
DELETE/ciam/v1/tenants/{tenant_id}/ip-pool-rules/{rule_id}
GET/ciam/v1/tenants/{tenant_id}/ip-pool-rules

### Example Data Plane APIs

gRPC
/api/sase/ciamservice/v1/AllocateIP
/api/sase/ciamservice/v1/ReleaseIP
/api/sase/ciamservice/v1/RenewIP

### REST

POST/ciam/v1/tenants/{tenant_id}/ip-reservation/allocate
POST/ciam/v1/tenants/{tenant_id}/ip-reservation/release
Post/ciam/v1/tenants/{tenant_id}/ip-reservation/renew

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive, at a gateway, a request for a secure tunnel connection for a mobile user endpoint to communicate with a secure access service edge (SASE) cloud environment;
assign a persistent private IP address for the secure tunnel connection to the mobile user endpoint; and
perform routing from the SASE cloud environment to the mobile user endpoint over a prioritized secure tunnel using a dynamic routing protocol (DRP) based on an associated sequence number; and
a memory coupled to the processor and configured to provide the processor with instructions.

2. The system of claim 1, wherein the mobile user endpoint comprises a mobile user, an application (app) associated with the mobile user, and/or a device associated with the mobile user.

3. The system of claim 1, wherein the SASE cloud environment is associated with a distributed SASE service.

4. The system of claim 1, wherein the secure tunnel connection comprises a virtual private network (VPN) connection between the mobile user endpoint and the SASE cloud environment.

5. The system of claim 1, wherein the secure tunnel connection comprises a virtual private network (VPN) connection between the mobile user endpoint and the SASE cloud environment via the gateway, wherein the gateway comprises a mobile user gateway.

6. The system of claim 1, wherein a cloud IP address management (CIAM) service receives the secure tunnel connection request and communicates with a global data store to facilitate a persistent private IP address allocation for the secure tunnel connection to the mobile user endpoint.

7. The system of claim 1, wherein a cloud IP address management (CIAM) service receives the secure tunnel connection request and communicates with a global data store to facilitate a persistent private IP address allocation for the secure tunnel connection to the mobile user endpoint, and wherein the private IP address allocation is associated with an IP address pool for a tenant of a SASE service associated with the mobile user endpoint.

8. The system of claim 1, wherein the processor is further configured to:
assign an incremented sequence number for each new private IP address allocation to the mobile user endpoint during establishment of a new secure tunnel connection request.

9. The system of claim 1, wherein the processor is further configured to:
remove an old tunnel at the gateway.

10. The system of claim 1, wherein the processor is further configured to:
remove an old tunnel at the gateway based on an associated timestamp.

11. The system of claim 1, wherein the processor is further configured to:
perform a duplicate secure tunnel detection using a cloud IP address management (CIAM) service of the SASE cloud environment and a global data store.

12. The system of claim 1, wherein the processor is further configured to:
detect a duplicate secure tunnel associated with the gateway and the mobile user endpoint using a cloud IP address management (CIAM) service of the SASE cloud environment and a global data store; and
send a notification to the gateway to release the private IP address associated with an old tunnel on the gateway.

13. The system of claim 1, wherein the processor is further configured to:
automatically perform a cleanup of old secure tunnels on the gateway in response to receiving a notification of the old secure tunnels from a cloud IP address management (CIAM) service of the SASE cloud environment.

14. A method, comprising:
receiving, at a gateway, a request for a secure tunnel connection for a mobile user endpoint to communicate with a secure access service edge (SASE) cloud environment;
assigning a persistent private IP address for the secure tunnel connection to the mobile user endpoint; and
performing routing from the SASE cloud environment to the mobile user endpoint over a prioritized secure tunnel using a dynamic routing protocol (DRP) based on an associated sequence number.

15. The method of claim 14, wherein the mobile user endpoint comprises a mobile user, an application (app) associated with the mobile user, and/or a device associated with the mobile user.

16. The method of claim 14, wherein the SASE cloud environment is associated with a distributed SASE service.

17. The method of claim 14, wherein the secure tunnel connection comprises a virtual private network (VPN) connection between the mobile user endpoint and the SASE cloud environment.

18. The method of claim 14, wherein the secure tunnel connection comprises a virtual private network (VPN) connection between the mobile user endpoint and the SASE cloud environment via the gateway, wherein the gateway comprises a mobile user gateway.

19. The method of claim 14, wherein a cloud IP address management (CIAM) service receives the secure tunnel connection request and communicates with a global data store to facilitate a persistent private IP address allocation for the secure tunnel connection to the mobile user endpoint.

20. A computer program product embodied in a non-transitory computer readable medium and comprising computer instructions for:
receiving, at a gateway, a request for a secure tunnel connection for a mobile user endpoint to communicate with a secure access service edge (SASE) cloud environment;
assigning a persistent private IP address for the secure tunnel connection to the mobile user endpoint; and
performing routing from the SASE cloud environment to the mobile user endpoint over a prioritized secure tunnel using a dynamic routing protocol (DRP) based on an associated sequence number.
